(19) United States
(12) Patent Application Publication
(10) Pub. No.: US 2021/0069876 A1
(43) Pub. Date: Mar. 11, 2021

(54) HIGH STRENGTH WRENCH

(71) Applicants: HUA WEI TOOLS CO., LTD., Yunlin County (TW); JOONG JYA ENTERPRISE CO., LTD., Taichung City (TW)

(72) Inventor: Zhong-Song LI, Yunlin County (TW)

(21) Appl. No.: 16/883,650

(22) Filed: May 26, 2020

(30) Foreign Application Priority Data
Sep. 5, 2019 (TW) 108132066

(51) Int. Cl. B25B 23/00; B25B 13/06

(52) U.S. Cl. CPC B25B 23/0035; B25B 13/06

(57) ABSTRACT

A high strength wrench includes a wrench body, a quick detachable unit, and a first sleeve unit. The wrench body includes a fitting hole extending in an axial direction. The quick detachable unit includes a quick detachable member partially inserted into the fitting hole and a quick detachable assembly disposed on the quick detachable member. The first sleeve unit includes a first sleeve body disposed in the fitting hole and a first accommodation hole formed through the first sleeve body. When the quick detachable member is surrounded by the first sleeve unit, torque caused by turning the sleeve and added to the quick detachable member can be evenly distributed by the inner surface of the first sleeve unit to prevent the quick detachable member from being easily broken and reinforce the strength of bearing the torque.

### BACKGROUND OF THE INVENTION

### 1. Field of the Invention

This invention relates to a hand tool and relates particularly to a wrench.

### 2. Description of the Related Art

FIG. 1 illustrates a conventional wrench 1 adapted to be detachably connected to a sleeve 15 for turning a screw 16. The wrench 1 includes a wrench body 11, a socket 12 penetrating through the wrench body 11, a quick detachable unit 13 disposed in the socket 12 and adapted to be detachably connected to the sleeve 15, and a quick detachable set 14 disposed on the quick detachable unit 13. The quick detachable unit 13 includes a fitting portion 131 engaged with the wrench body 11 and an operating portion 132 connected to the fitting portion 131 and having an outer diameter smaller than the fitting portion 131. The quick detachable set 14 includes a ball 141 adapted to be braced against the sleeve 15 and an elastic unit 142 connected to the ball 131 and disposed in the operating portion 132. The elastic unit 142 pushes the ball 141 in an opposing direction in responsive to the movement of the quick detachable unit 13 so that the ball 141 is braced against the sleeve 15. When the sleeve 15 is connected to the wrench body 11 by the quick detachable set 14, the sleeve 15 is subjected to frictional resistance caused by the ball 141 to prevent an easy escape while turning the screw 16.

If the user needs to replace different sizes of sleeves 15, he needs to add force to move the sleeve 15 in a direction opposite to the wrench body 11, namely in a downward direction shown in FIG. 1. When the added force is larger than the frictional resistance caused between the ball 141 and the sleeve 15, the sleeve 15 can be detached from the wrench body 11.

However, a great deal of stress maybe concentrated on the operating portion 132 which is in contact with the sleeve 15 while turning the screw 16. Thus, the place where the operating portion 132 and the fitting portion 131 meet breaks easily by an increase in turning torque, which leads to the replacement of the quick detachable unit 13.

### SUMMARY OF THE INVENTION

An object of this invention is to provide a high strength wrench capable of reinforcing the strength of bearing torque.

The high strength wrench of this invention is adapted to be detachably engaged with a sleeve and includes a wrench body, a quick detachable unit, and a first sleeve unit.

The wrench body includes a fitting hole extending in an axial direction.

The quick detachable unit includes a quick detachable member partially inserted into the fitting hole and a quick detachable assembly disposed on the quick detachable member so that the sleeve is detachably engaged with the quick detachable member.

The first sleeve unit includes a first sleeve body disposed in the fitting hole and a first accommodation hole formed through the first sleeve body in the axial direction. The first sleeve body has an inner surface adapted to surround a portion of the quick detachable member. The first accommodation hole is enclosed by the inner surface. The quick detachable member penetrates through the first accommodation hole, thereby allowing the first sleeve unit to rotate with the sleeve by the quick detachable member. At least the first sleeve unit is engaged with the wrench body for limiting a position of the quick detachable member.

A significant effect of this invention is that when the quick detachable member is surrounded by the first sleeve unit, torque caused by turning the sleeve and added to the quick detachable member can be evenly distributed over the whole surface where the quick detachable member and the first sleeve unit meet because of the inner surface of the first sleeve unit, and this arrangement prevents the quick detachable member from being easily broken to thereby reinforce the strength of bearing the torque.

### BRIEF DESCRIPTION OF THE DRAWINGS

Other features and effects of this invention will become better understood by reference to the preferred embodiments when considered in connection with the accompanying drawings and wherein:

FIG. 1 is a cross-sectional view showing a conventional wrench;

FIG. 2 is a partial exploded view showing a first preferred embodiment of a high strength ratchet wrench of this invention;

FIG. 3 is a partial perspective view showing an engagement between the first preferred embodiment and a sleeve;

FIG. 4 is a cross-sectional view showing the engagement between the first preferred embodiment and the sleeve;

FIGS. 5 and 6 are cross-sectional views showing a second preferred embodiment of a high strength ratchet wrench of this invention and a sleeve when a quick detachable member of the second preferred embodiment assumes a first position and a second position respectively;

FIG. 7 is a partial exploded view showing a third preferred embodiment of a high strength ratchet wrench of this invention;

FIGS. 8 and 9 are cross-sectional views showing the engagement between the third preferred embodiment and the sleeve when a quick detachable member of the third preferred embodiment assumes a first position and a second position respectively;

FIG. 10 is a cross-sectional view showing a fourth preferred embodiment of a high strength ratchet wrench of this invention;

FIG. 11 is a cross-sectional view showing a variation of the fourth preferred embodiment; and

FIG. 12 is a cross-sectional view showing a fifth preferred embodiment of a high strength ratchet wrench of this invention.

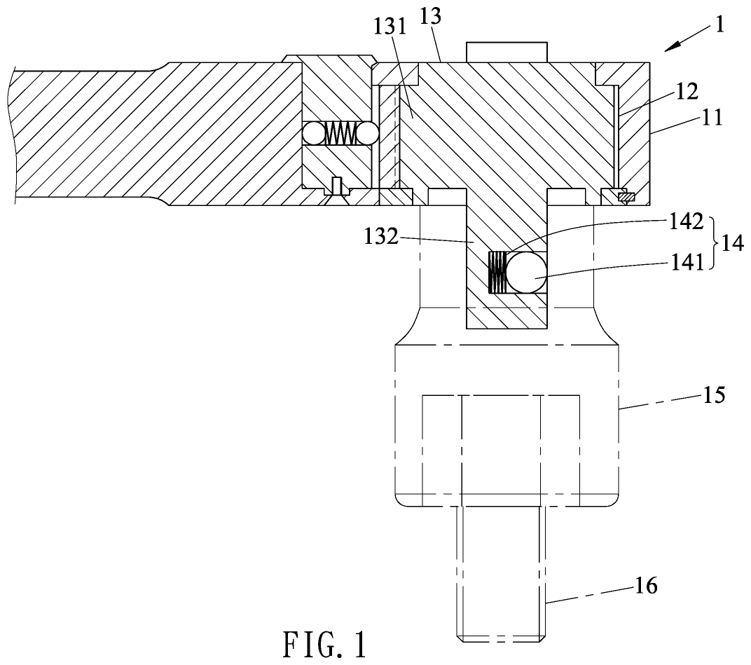

### DETAILED DESCRIPTION OF THE PREFERRED EMBODIMENTS

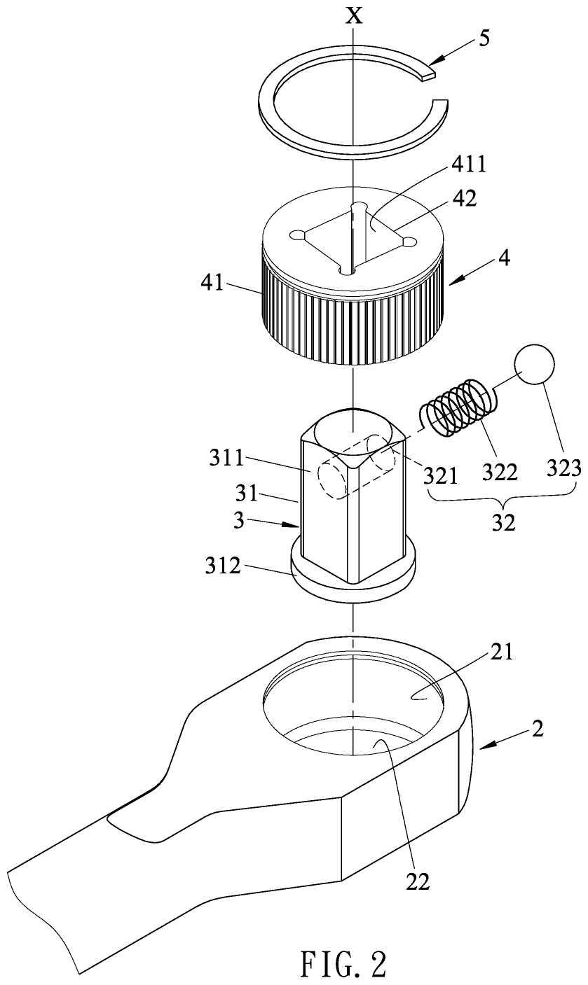

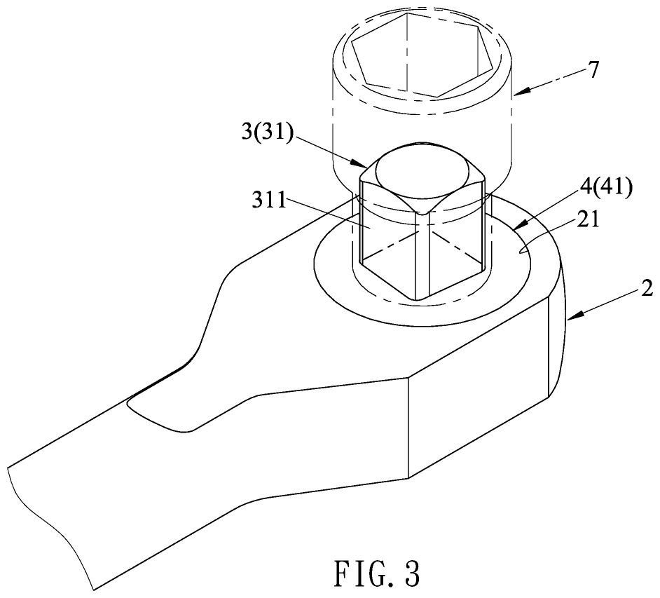

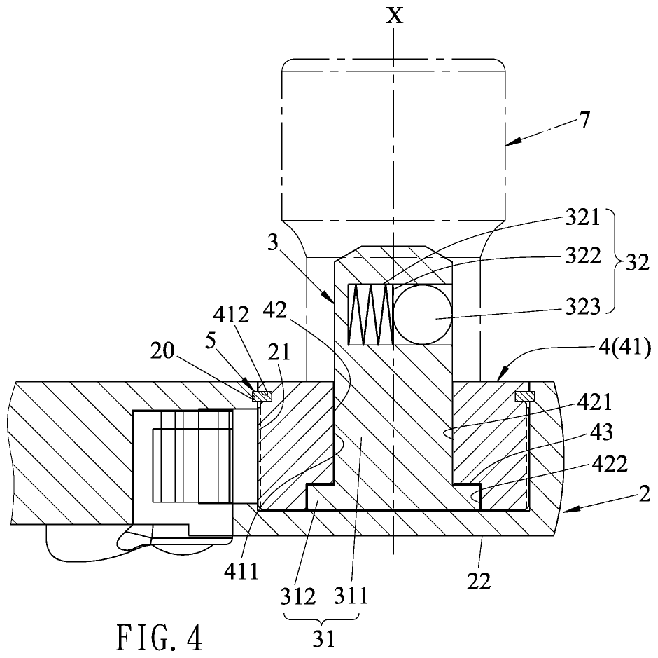

Referring to FIG. 2, FIG. 3, and FIG. 4, a first preferred embodiment of a high strength wrench of this invention is adapted to be detachably engaged with a sleeve 7 and includes a wrench body 2, a quick detachable unit 3, and a first sleeve unit 4, and a C-type ring 5.

The wrench body 2 includes a fitting hole 21 which extends in an axial direction X and is closed at one end and a support portion 22 formed at the closed end of the fitting hole 21. A wrench recess 20 is formed inside the fitting hole 21.

In this preferred embodiment, the fitting hole 21 can be an opening which is closed at one end. Alternatively, it is possible in a variation of this preferred embodiment that the fitting hole 21 is an opening which is open at two ends.

The quick detachable unit 3 includes a quick detachable member 31 partially inserted into the fitting hole 21 and a quick detachable assembly 32 disposed on the quick detachable member 31 for allowing the sleeve 7 to be detachably engaged with the quick detachable member 31.

The quick detachable member 31 includes a collar portion 312 disposed in the fitting hole 21 and a first quick detachable portion 311 extending outwards from the collar portion 312 in a direction opposite to the support portion 22 and having an outer diameter smaller than the collar portion 312.

The quick detachable assembly 32 includes a first quick hole 321 formed on the first quick detachable portion 311, a first elastic unit 322 disposed in the first quick hole 321, and a first ball 323 partial disposed in the first quick hole 321 and adapted to be braced against the sleeve 7.

The first sleeve unit 4 includes a first sleeve body 41 installed in the fitting hole 21, a first accommodation hole 42 formed through the first sleeve body 41 in the axial direction X, and a first flange 43 formed on an inner side for dividing the first accommodation hole 42 into a first accommodation portion 421 and a first shift portion 422.

The first sleeve body 41 has an inner surface 411 and a recess 412 formed on the inner surface 412. The first accommodation hole 42 is enclosed by the inner surface 411 for surrounding a portion of the quick detachable member 31. A shape of the first accommodation hole 42 fits the quick detachable member 31 to allow the quick detachable member 31 to be engaged with the first accommodation hole 42 for limiting its position.

The first quick detachable portion 311 penetrates through the first accommodation portion 421. A hole diameter of the first shift portion 422 is larger than a hole diameter of the first accommodation portion 421 for accommodating the collar portion 312. Generally, the first quick detachable portion 311 is a post formed in a non-circular shape. Accordingly, when the first sleeve unit 4 is sleevedly disposed on the quick detachable member 31, the first sleeve unit 4 is actuated by the quick detachable member 31 so that the first sleeve unit 4 rotates with the sleeve 7 by the quick detachable member 31.

The first flange 43 cooperates with the support portion 22 for limiting a position of the collar portion 312.

Particularly, in this preferred embodiment, the first flange 43 is formed on a corner between the first accommodation portion 421 and the first shift portion 422, and the hole diameter of the first accommodation portion 421 is smaller than the hole diameter of the first shift portion 422. Alternatively, it is possible in a variation of this preferred embodiment that only the first accommodation portion 421 is defined, and the first flange 43 is formed on an edge of the first sleeve body 41 in the proximity to the support portion 22, thereby limiting the position of the collar portion 312 by cooperating the first flange 43 with the support portion 22.

The C-type ring 5 is disposed between the recess 412 of the first sleeve unit 4 and the wrench recess 20 of the wrench body 2 so that a position of the first sleeve unit 4 is limited within the wrench body 2 to prevent an easy escape.

Referring to FIG. 4, the assembly or installation of this invention is executed by following steps. Firstly, insert the first quick detachable portion 311 of the quick detachable member 31 into the first accommodation portion 421 of the first sleeve unit 4 to allow the collar portion 312 of the quick detachable member 31 to abut against the first flange 43. When the quick detachable member 31 and the first sleeve unit 4 are connected together, put both of the quick detachable member 31 and the first sleeve unit 4 and the C-type ring 5 into the fitting hole 21 so that the position of the collar portion 312 is limited to be located between the first flange 43 and the support portion 22, and the C-type ring 5 is situated between the first sleeve unit 4 and the wrench body 2, thereby completing the installation.

Regarding a turning operation, it requires the steps of abutting the sleeve 7 against one end of the quick detachable member 31 far away from the wrench body 2 and then pressing the sleeve 7 shown in FIG. 4 in a downward direction to make the sleeve 7 approach the wrench body 2. During the pressing action, the first ball 323 is pressed by an inner peripheral surface of the sleeve 7 to compress the first elastic unit 322, and the first elastic unit 322 pushes the first ball 323 outwards by its permanent elasticity to brace the first ball 323 against the sleeve 7. Accordingly, frictional resistance is caused between the first ball 323 and the sleeve 7 to prevent the sleeve 7 from escaping from the quick detachable member 31 while turning the sleeve 7.

Therefore, because the first quick detachable portion 311 is surrounded by the inner surface 411 of the first sleeve unit 41, torque caused by the sleeve 7 can be evenly distributed to prevent the place where the collar portion 312 and the first quick detachable portion 311 meet from being easily broken.

From above, the advantage of the preferred embodiment is described as follows:

The first sleeve unit 4 disposed around the quick detachable member 31 allows torque caused by turning the sleeve 7 and added to the quick detachable member 31 to be evenly distributed over the whole surface where the quick detachable member 31 and the first sleeve unit 4 meet by the inner surface 411 of the first sleeve unit 4. Thus, the quick detachable member 31 is not easily broken to reinforce the strength of bearing the torque.

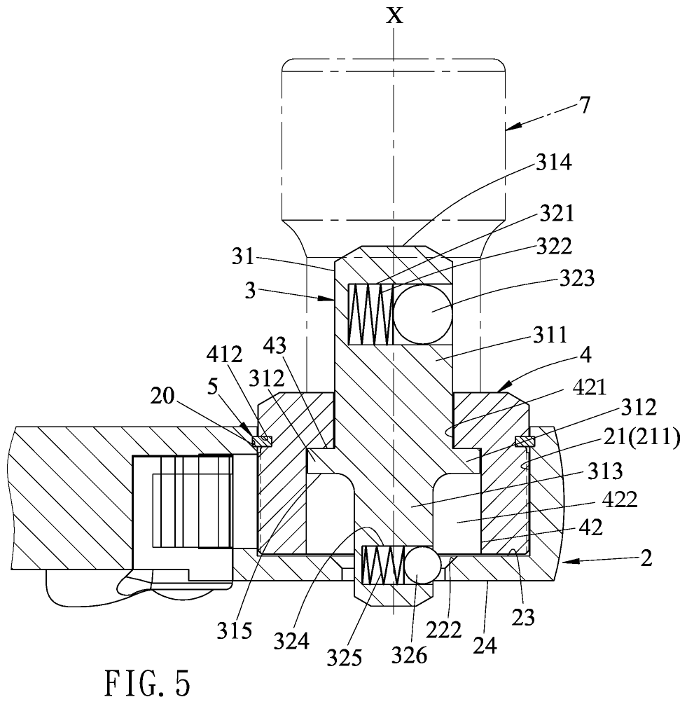

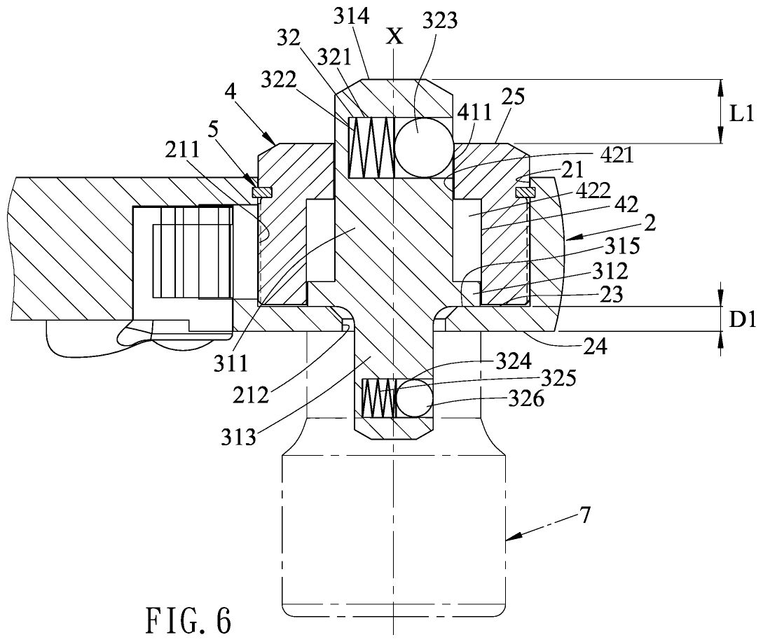

FIGS. 5 to 6 illustrate a second preferred embodiment of the high strength wrench where all elements are almost the same as those elements previously described in the first preferred embodiment, namely the wrench body 2, the quick detachable unit 3, the first sleeve unit 4, and the C-type ring 5. The second preferred embodiment differs from the first preferred embodiment in having following features:

1. The fitting hole 21 is a through hole. The wrench body 2 includes a fitting flange 23 formed on an inner peripheral surface of the wrench body 2 for dividing the fitting hole 21 into a fitting portion 211 and a perforated portion 212, a fitting side surface 24 defined near one end of the fitting flange 23, and an outer side surface 25 opposite to the fitting side surface 24.

2. The quick detachable member 31 includes a second quick detachable portion 313 extending from the collar portion 312 in a direction opposite to the first quick detachable portion 311. An outer diameter of the second quick detachable portion 313 is smaller than an outer diameter of the collar portion 312, and the second quick detachable portion 313 penetrates through the perforated portion 212.

3. The quick detachable assembly 32 includes a second quick hole 324 formed on the second quick detachable portion 313, a second elastic unit 325 disposed in the second quick hole 324, and a second ball 326 partially disposed in the second quick hole 324 and adapted to be pushed outwards by the second elastic unit 325.

The fitting portion 211 is adapted to accommodate the collar portion 312, the first quick detachable portion 311, and the second quick detachable portion 313.

A maximum outer diameter of the second quick detachable portion 313 is different from a maximum outer diameter of the first quick detachable portion 311. In this preferred embodiment, the maximum outer diameter of the second quick detachable portion 313 is smaller than the maximum outer diameter of the first quick detachable portion 311. It is noted that the embodiment is not limiting on the scope of this invention.

The first quick detachable portion 311 has a quick end surface 314 far away from the second quick detachable portion 313. The collar portion 312 has a stop surface 315 facing the second quick detachable portion 313.

Particularly, the concatenation, the operation, and the effect of correlated elements such as the second quick detachable portion 313, the second quick hole 324, the second elastic unit 325, and the second ball 326 are similar to those of the elements such as the first quick detachable portion 311, the first quick hole 321, the first elastic unit 322, and the first ball 323 described in the previous preferred embodiment and herein are omitted.

The quick detachable member 31 is movable between a first position (shown in FIG. 5) and a second position (shown in FIG. 6) in the axial direction X. When the quick detachable member 31 is in the first position, the first quick detachable portion 311 projecting upwards from the fitting hole 21, and at least a portion of the second quick detachable portion 313 is situated in the fitting portion 211. Meanwhile, the collar portion 312 abuts against the first flange 43 to allow the first quick detachable portion 311 to be detachably engaged with the sleeve 7. The first ball 323 is also adapted to be pushed against the sleeve 7. When the quick detachable member 31 is in the second position, the second quick detachable portion 313 projecting downwards from the fitting hole 21, and at least a portion of the first quick detachable portion 311 is situated in the fitting portion 211. Meanwhile, the collar portion 312 abuts against the fitting flange 23 to allow the second quick detachable portion 313 to be detachably engaged with the sleeve 7. The second ball 326 is also adapted to be pushed against the sleeve 7.

When the quick detachable member 31 is in the second position, a first distance D1 is defined between the stop surface 315 of the collar portion 312 and the fitting side surface 24, and a first projecting length L1 is defined from the quick end surface 314 of the first quick detachable portion 311 to the outer side surface 25.

The operation of the second preferred embodiment is executed by pushing one quick detachable portion selected from the first quick detachable portion 311 or the second quick detachable portion 313 towards the other quick detachable portion, thereby moving the quick detachable member 31 to the first position or to the second position. For example, when the first quick detachable portion 311 shown in FIG. 5 is pressed downwards, that is, in the direction of the second quick detachable portion 313, the quick detachable member 31 is moved to assume the second position shown in FIG. 6.

Accordingly, the second preferred embodiment not only uses the first sleeve unit 4 disposed around the quick detachable member 31 to increase the strength of bearing the torque but also allows a single quick detachable member 31 to work with two different sizes of sleeves 7 by using the two quick detachable portions 311, 313 with different outer diameters. Thus, the scope of the use is enlarged.

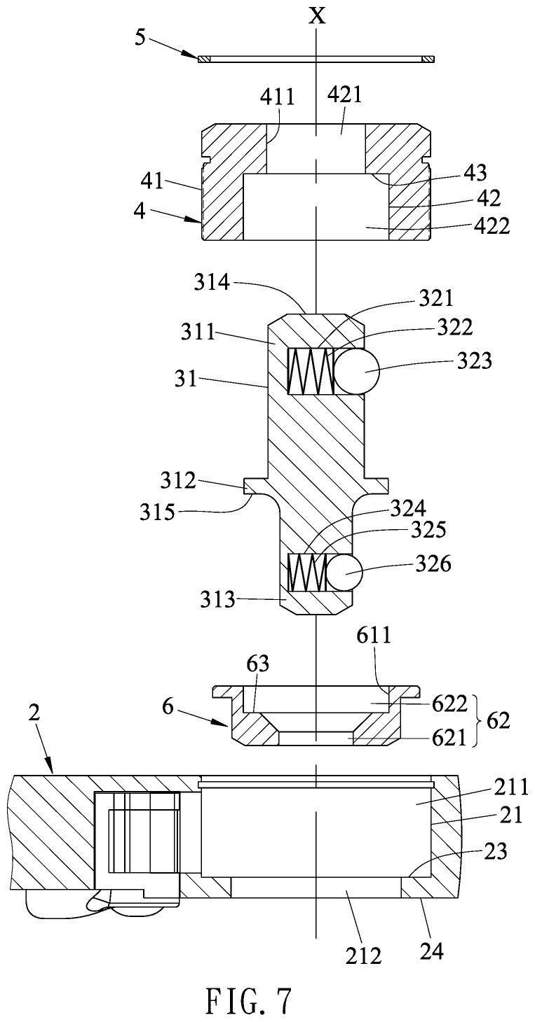

FIGS. 7 to 9 illustrate a third preferred embodiment of the high strength wrench where all elements are almost the same as those elements previously described in the second preferred embodiment, namely the wrench body 2, the quick detachable unit 3, the first sleeve unit 4, and the C-type ring 5. The third preferred embodiment differs from the second preferred embodiment in having following features:

The third preferred embodiment includes a second sleeve unit 6.

The second sleeve unit 6 penetrates through the perforated portion 212 and abuts against the fitting flange 23. The second sleeve unit 6 includes a second sleeve body 61, a second accommodation hole 62 formed through the second sleeve body 61 in the axial direction X, and a second flange 63. The second sleeve body 61 has an inner peripheral surface 611, and a portion of the second quick detachable portion 313 is surrounded by the inner peripheral surface 611. The second flange 63 is formed on the inner peripheral surface 611.

The second quick detachable portion 313 penetrates through the second accommodation hole 62. A second accommodation portion 621 and a second shift portion 622 can be defined in the second accommodation hole 62 by the second flange 63. The second quick detachable portion 313 penetrates through the second accommodation portion 621. A hole diameter of the second shift portion 622 is larger than a hole diameter of the second accommodation portion 621 for accommodating the collar portion 312.

Because the second quick detachable portion 313 is generally formed in a non-circular shape, the second sleeve unit 6 sleevedly disposed on the second quick detachable portion 313 allows the second sleeve unit 6 to be actuated by the second quick detachable portion 313 so that the second sleeve unit 6 rotates with the sleeve 7 by the second quick detachable portion 313, and the first sleeve unit 4 and the second sleeve unit 6 engage with the wrench body 2 for limiting the position of the quick detachable member 31.

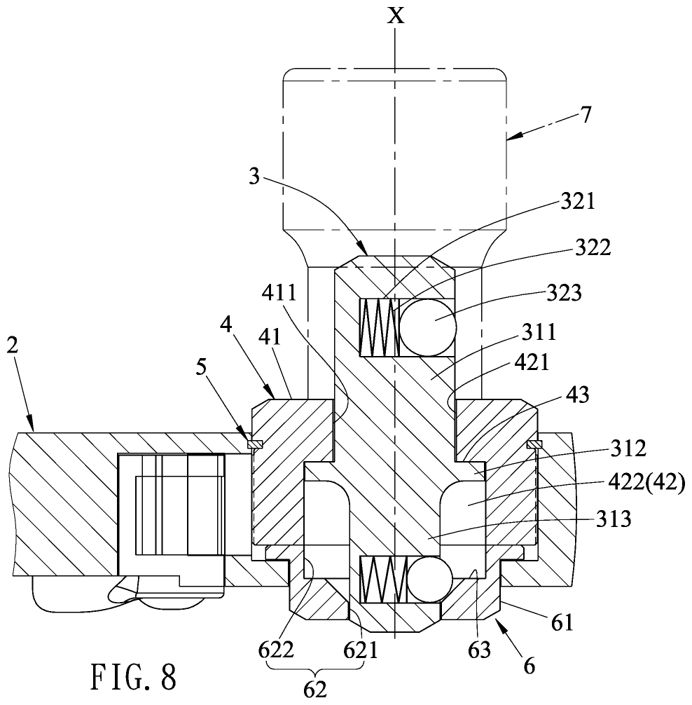

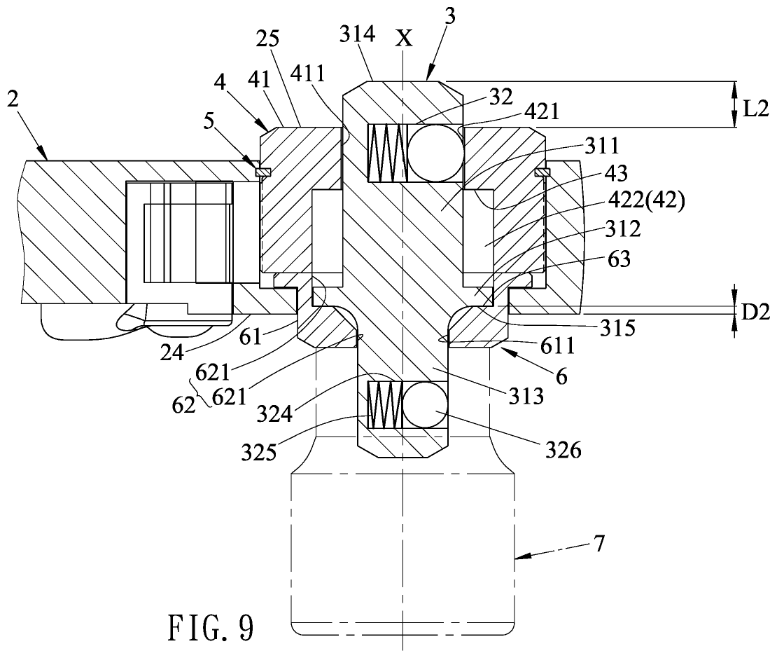

When the quick detachable member 31 is in the first position (shown in FIG. 8), the first quick detachable portion 311 projecting upwards from the fitting hole 21, and at least a portion of the second quick detachable portion 313 is situated in the fitting portion 211. Meanwhile, the collar portion 312 is situated in the first shift portion 422 and abuts against the first flange 43, and concurrently the inner surface 411 of the first sleeve unit 4 surrounds the first quick detachable portion 311. When the quick detachable member 31 is in the second position (shown in FIG. 9), the collar portion 312 is situated in the second shift portion 622 and abuts against the second flange 63. Meanwhile, the inner peripheral surface 611 of the second sleeve unit 6 surrounds the second quick detachable portion 313.

Accordingly, torque added to the second quick detachable portion 313 during the turning operation can be distributed over the whole surface where the quick detachable member 31 and the second sleeve unit 6 meet by using the second sleeve unit 6, thereby reinforcing the strength of bearing the torque and preventing the breaking problem. It is noted that the aforementioned configuration of this preferred embodiment allows the quick detachable member 31 to possess the torsional strength which is from 1.5 to 2 times the torsional strength utilizing ANSI (American National Standards Institute) standards.

Referring to FIG. 6 and FIG. 9, it is noted that when the quick detachable member 31 is in the second position shown in FIG. 9, a second distance D2 is defined between the stop surface 315 of the collar portion 312 and the fitting side surface 24, and a second projecting length L2 is defined from the quick end surface 314 of the first quick detachable portion 311 to the outer side surface 25. It is noted that the second distance D2 of the third preferred embodiment shown in FIG. 9 can be small in comparison with the first distance D1 of the second preferred embodiment shown in FIG. 6 because the stop surface 315 is closer to the fitting side surface 24 when the collar portion 312 is accommodated in the second accommodation hole 62 of the second sleeve unit 6. Thus, the second projecting length L2 can be smaller than the first projecting length L2. In other words, by comparison with the second preferred embodiment, the third preferred embodiment reduces the projecting length defined by projecting the first quick detachable portion 311 from the wrench body 2 to thereby adapt this embodiment to a smaller working space.

From above, the third preferred embodiment not only attains the effects of the previous embodiment but also uses the inner peripheral surface 611 of the second sleeve unit 6 which surrounds a portion of the second quick detachable portion 313 to afford the second quick detachable portion 313 increased strength of bearing the torque. Therefore, both ends of the quick detachable member 31 are not easily broken. Furthermore, the second accommodation hole 62 of the second sleeve unit 6 allows the stop surface 315 to be closer to the fitting side surface 24 when the quick detachable member 31 is in the second position. Considering the relationship between the wrench body 2 and a fixed full length of the quick detachable member 31 extending in the axial direction X, the length defined by projecting the first quick detachable portion 311 from the wrench body 2 can be reduced.

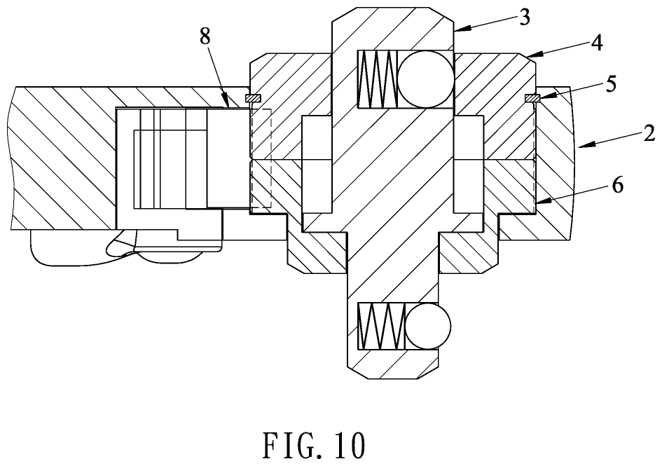

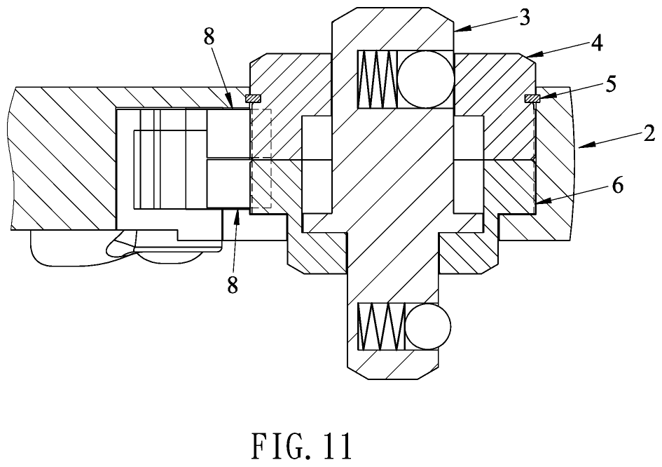

FIGS. 10 to 11 illustrate a fourth preferred embodiment of the high strength wrench where all elements are almost the same as those elements previously described in the third preferred embodiment, namely the wrench body 2, the quick detachable unit 3, the first sleeve unit 4, the C-type ring 5, and the second sleeve unit 6. The fourth preferred embodiment differs from the third preferred embodiment in having following features:

An outer surface of the first sleeve unit 4 is formed with ratchet teeth, and an outer surface of the second sleeve unit 6 is formed with ratchet teeth.

A set of triangular teeth 8 can be formed. Thus, the triangular teeth 8 can mesh with the ratchet teeth formed on the outer surfaces of the first sleeve unit 4 and the second sleeve unit 6 concurrently to change the turning direction.

Furthermore, it is possible in a variation of this preferred embodiment that two sets of triangular teeth 8 are formed so that the two sets of triangular teeth 8 are respectively disposed relative to the ratchet teeth of the first sleeve unit 4 and the ratchet teeth of the second sleeve unit 6 to thereby increase the strength of bearing the torque.

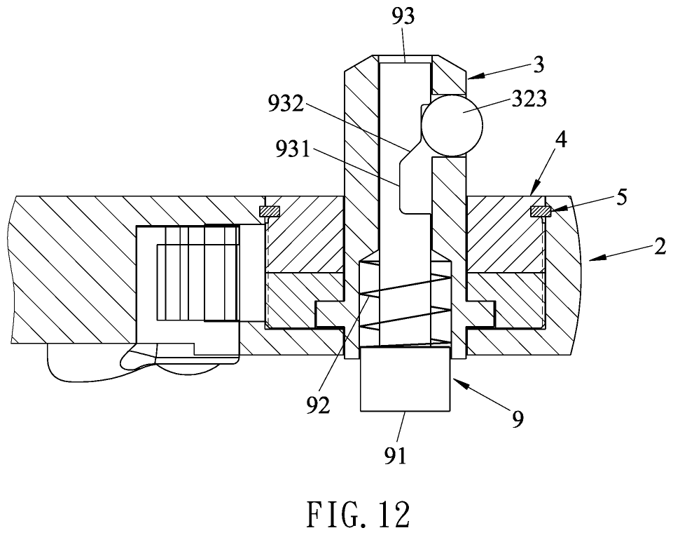

FIG. 12 illustrates a fifth preferred embodiment of the high strength wrench where all elements are almost the same as those elements previously described in the first preferred embodiment, namely the wrench body 2, the quick detachable unit 3, the first sleeve unit 4, and the C-type ring 5. The fifth preferred embodiment differs from the first preferred embodiment in having following features:

The high strength wrench includes a quick releasing unit 9 disposed in the quick detachable member 3. The quick releasing unit 9 includes a press member 91 disposed in quick detachable member 3, a spring 92 connected to the press member 91, and a quick releasing member 93 connected to the press member 91 and serving to be in contact with the first ball 323. The quick releasing member 93 has a recessed portion 931 and a beveled surface 932 connected to the recessed portion 931.

The user presses the press member 91 to move the quick releasing member 93 shown in FIG. 12 towards the left. Therefore, the first ball 323 is allowed to aim at and move into the recessed portion 931, which renders the sleeve shown in FIG. 9 able to be detached from the quick detachable unit 3.

From above, the fifth preferred embodiment not only attains the effects of the previous embodiment but also detaches the sleeve 7 shown in FIG. 9 in a convenient manner by using the quick releasing unit 9.

While the embodiments are shown and described above, it is understood that the embodiments related to this invention should not limit the scope of this invention and that further variations and modifications may be made without departing from the scope of this invention.

What is claimed is:

1. A high strength wrench adapted to be detachably engaged with a sleeve, said high strength wrench comprising:
a wrench body including a fitting hole extending in an axial direction;
a quick detachable unit including a quick detachable member partially inserted into said fitting hole and a quick detachable assembly disposed on said quick detachable member for engaging said sleeve with said quick detachable member in a detachable manner; and
a first sleeve unit including a first sleeve body disposed in said fitting hole and a first accommodation hole formed through said first sleeve body in said axial direction, said first sleeve body having an inner surface by which said first accommodation hole is enclosed for surrounding a portion of said quick detachable member, said quick detachable member penetrating through said first accommodation hole to allow said first sleeve unit to rotate with said sleeve by said quick detachable member, an engagement between at least said first sleeve unit and said wrench body serving to limit a position of said quick detachable member.

2. The high strength wrench according to claim 1, wherein a shape of said first accommodation hole fits said quick detachable member to allow said quick detachable member to be engaged with said first accommodation hole.

3. The high strength wrench according to claim 1, wherein said quick detachable member includes a collar portion disposed in said fitting hole and a first quick detachable portion extending outwards from said collar portion and having an outer diameter smaller than said collar portion, said first sleeve unit including a first flange formed on said inner surface for dividing said first accommodation hole into a first accommodation portion and a first shift portion, said first quick detachable portion penetrating through said first accommodation portion, a hole diameter of said first shift portion being larger than a hole diameter of said first accommodation portion for accommodating said collar portion.

4. The high strength wrench according to claim 3, wherein said fitting hole is defined as an opening extending in said axial direction and having a closed end, said wrench body including a support portion formed at said closed end, said collar portion being capable of abutting against said support portion, a position of said collar portion being limited between said first flange and said support portion.

5. The high strength wrench according to any one of claims 3, wherein said quick detachable assembly includes a first quick hole formed on said first quick detachable portion, a first elastic unit disposed in said first quick hole, and a first ball partial disposed in said first quick hole and adapted to be pushed outwards by said first elastic unit for bracing said first ball against said sleeve.

6. The high strength wrench according to claim 3, wherein said wrench body includes a fitting flange formed on an inner peripheral surface of said wrench body for dividing said fitting hole into a fitting portion and a perforated portion, said collar portion and said first quick detachable portion being disposed in said fitting portion, said quick detachable member including a second quick detachable portion extending from said collar portion in a direction opposite to said first quick detachable portion, said second quick detachable portion having an outer diameter smaller than an outer diameter of said collar portion and penetrating through said perforated portion, a maximum outer diameter of said first quick detachable portion being different from a maximum outer diameter of said second quick detachable portion, said quick detachable member being movable between a first position and a second position in said axial direction, said first quick detachable portion projecting from said fitting hole, and at least a portion of said second quick detachable portion being situated in said fitting portion when said quick detachable member assumes said first position to thereby allow said first quick detachable portion to be detachably engaged with said sleeve, said second quick detachable portion projecting from said fitting hole and at least a portion of said first quick detachable portion being situated in said fitting portion when said quick detachable member assumes said second position to thereby allow said second quick detachable portion to be detachably engaged with said sleeve.

7. The high strength wrench according to claim 6, wherein said collar portion abuts against said first flange when said quick detachable member assumes said first position, and said collar portion abuts against said fitting flange when said quick detachable member assumes said second position.

8. The high strength wrench according to any one of claims 6, wherein said quick detachable assembly includes a first quick hole formed on said first quick detachable portion, a first elastic unit disposed in said first quick hole, a first ball partially disposed in said first quick hole and adapted to be pushed outwards by said first elastic unit, a second quick hole formed on said second quick detachable portion, a second elastic unit disposed in said second quick hole, and a second ball partially disposed in said second quick hole and adapted to be pushed outwards by said second elastic unit, said first ball being adapted to be braced against said sleeve when said quick detachable member assumes said first position, said second ball being adapted to be braced against said sleeve when said quick detachable member assumes said second position.

9. The high strength wrench according to claim 6, further comprising a second sleeve unit penetrating through said perforated portion and abutting against said fitting flange, said second sleeve unit including a second sleeve body disposed around a portion of said quick detachable member and a second accommodation hole formed through said second sleeve body in said axial direction and adapted to accommodate said second quick detachable portion to thereby allow said second sleeve unit to rotate with said sleeve by said quick detachable member, said first sleeve unit and said second sleeve unit being engaged with said wrench body for limiting the position of said quick detachable member.

10. The high strength wrench according to claim 9, wherein said second sleeve unit includes a second flange formed on an inner peripheral surface of said second sleeve unit for dividing said second accommodation hole into a second accommodation portion and a second shift portion, said second quick detachable portion penetrating through said second accommodation portion, a hole diameter of said second shift portion being larger than a hole diameter of said second accommodation portion for accommodating said collar portion, said collar portion being situated in said first shift portion when said quick detachable member assumes said first position, said collar portion being situated in said second shift portion when said quick detachable member assumes said second position.

11. The high strength wrench according to claim 10, wherein said collar portion abuts against said first flange when said quick detachable member assumes said first position, and said collar portion abuts against said second flange when said quick detachable member assumes said second position.

12. The high strength wrench according to any one of claims 9, wherein said quick detachable assembly includes a first quick hole formed on said first quick detachable portion, a first elastic unit disposed in said first quick hole, a first ball partially disposed in said first quick hole and adapted to be pushed outwards by said first elastic unit, a second quick hole formed on said second quick detachable portion, a second elastic unit disposed in said second quick hole, and a second ball partially disposed in said second quick hole and adapted to be pushed outwards by said second elastic unit, said first ball being adapted to be braced against said sleeve when said quick detachable member assumes said first position, said second ball being adapted to be braced against said sleeve when said quick detachable member assumes said second position.
